(19) United States
(12) Patent Application Publication
(10) Pub. No.: US 2020/0004217 A1
(43) Pub. Date: Jan. 2, 2020

(54) Packaging Plant Data Exchange and Method for Operating a Packaging Plant Data Exchange

(71) Applicant: SIG Technology AG, Neuhausen am Rheinfall (CH)

(72) Inventors: Matthias Eickhoff, Alsdorf (DE); Stefan Maus, Eschweiler (DE); Markus Schneider, Dormagen (DE)

(21) Appl. No.: 16/485,590

(22) PCT Filed: Jan. 11, 2018
(86) PCT No.: PCT/EP2018/050605

§ 371 Date: Aug. 13, 2019

(30) Foreign Application Priority Data
Feb. 15, 2017 (DE) 10 2017 103 017.4

(51) Int. Cl. G05B 19/042; B65G 43/10

(52) U.S. Cl. CPC G05B 19/0423; G05B 2219/45048; B65G 43/10

(57) ABSTRACT

Packaging plant data exchange comprising at least one intermediate store for packaging plant status data comprising status values, at least one data input interface, the data input interface communicating with at least one program module adapted to a packaging device of the packaging plant, characterized in that the program module creates a machine data object comprising at least metadata of the packaging device via a data input interface.

The subject matter relates to a packaging plant data exchange, a method for operating a packaging plant data exchange, a computer program and a server for a packaging plant data exchange.

There are packaging plants in which a large number of different equipment and components are frequently used, such as filling machines, applicators for applying closures and/or straws, switches, case packers and cartoners. These facilities mostly originate from different manufacturers and provide packaging plant data such as packaging plant condition data representative of the condition of the respective facilities in different data formats for processing by a packaging plant data exchange and/or other facilities/components of the packaging plant. Also, facilities of different manufacturers provide different packaging machine data sets.

A problem with these packaging plants is therefore that the packaging plant data provided by the equipment of the packaging plant cannot be processed and evaluated uniformly due to the different data formats, so that individual solutions for processing and evaluation of the packaging plant data must be developed for each packaging plant.

Packaging plants are also frequently subsequently expanded, so that the solutions for processing and evaluation of the packaging plant data also have to be expanded and adapted accordingly.

Therefore, the object was to provide a flexible data management for packaging plants, which can be easily adapted to different machine interfaces of different packaging equipment and components.

This object is solved by means of a packaging plant data exchange device according to claim 1. Furthermore, the object is solved by a method of Claim 15, a computer program of Claim 17 and a system of Claim 18.

As already described above, a packaging plant can be understood as a system for packaging goods such as foodstuffs. In particular, a packaging plant may be understood as a beverage filling line and/or a part of a beverage filling line. Such systems often use a variety of different components such as filling machines, applicators for applying closures and/or drinking straws, switches, case packers and cartoners. Various applications run on these devices (e.g. in the form of a computer program executed by a processor of this component). The various components and applications of the packaging plant provide packaging plant data (in particular packaging plant condition data, condition data or condition values of parameters of the packaging plant) in various data formats and/or via various machine interfaces for processing by a packaging plant data exchange and/or other equipment and/or applications. The information exchanged with the machine interfaces can then be processed with software interfaces as described below.

From practical experience, cardboard/plastic/metal composite packages are known to be used for various flowable or pourable products. The main area of application for such carton/plastic/metal composite packs is the packaging of beverages and heat-treated, in particular pasteurised foodstuffs. The well-known packings and packages are available in different shapes. These are typically rectangular, cubic and cylindrical. A major difference still exists, for example, with regard to the packing head, which is predominantly designed as a so-called flat gable or slanted gable.

Packages can be produced in different ways and from different materials. A widely used way of manufacturing them is to make a blank from the packaging material, from which, by folding and other steps, a pack sleeve is first produced and one end of which can be sealed. The pack can then be filled through the still at least partially open part of the pack sleeve. In some of these processes, a pack blank is formed onto a mandrel of a mandrel wheel.

One of the advantages of this production method is that the blanks and pack sleeves are very flat and can therefore be stacked to save space. In this way, the blanks or sleeves can be produced at a different location from that at which the sleeves are folded and filled. Composites are often used as a material, for example a composite of several thin layers of paper, cardboard, plastic or metal, especially aluminum. Such packaging is widely used in the food industry in particular.

A packaging plant data exchange can be understood, for example, as a function provided by a server device or a server system (e.g. the present server device or the present server system, which can be formed both virtually and directly) for switching packaging plant status data (packaging plant parameters and/or status data or status values) between different applications and/or devices/components of a packaging plant. For example, packaging plant data exchange is provided by a computer program (e.g. the present computer program) executed by at least parts of a processor of the server device or system. For example, the computer program is a middleware program and/or a service layer program.

For example, a buffer of the packaging plant data transfer contains only a limited number of status values for different states of the packaging plant. For example, a buffer memory of the packaging plant data exchange only contains current status values for different statuses of the packaging plant.

It goes without saying that an intermediate storage of the packaging plant data exchange in embodiments can also include a limited number of historical condition values for the different states of the packaging plant in addition to the current condition values for different states of the packaging plant. The status value of a status date or variable can be different at different times. It is possible to store a current status value and, if necessary, historical status values for a variable or a status date. Status values can be provided with a time stamp, so that a temporal assignment of a status value is possible and a temporal sequence of status values of a status date can be reconstructed.

For example, the buffer serves as a cache to prevent the packaging plant data exchange from having to access the persistent memory to access each status value. The buffer can also serve as a cache to buffer downtime in the persistent data store. The buffer memory can bridge downtimes between the packaging plant data exchange and the persistent memory. In particular, the buffer memory is formed as a bidirectional memory that enables both read and write access.

For example, the buffer of the packaging plant data exchange is part of a memory (e.g. a program and/or main memory) of the server device providing the packaging plant data exchange or of the virtual server providing the packaging plant data exchange.

The packaging plant data exchange, in particular a program module, implements at least one instance of a data input interface for communicating with equipment/components and/or applications of the packaging plant via the program module. When we talk about a data input interface, reference can also be made to an instance of a data input interface. In particular, a program module or an instance of a program module can provide methods for instantiating instances of data input interfaces, or a program module can provide a method as a data input interface.

It is understood that the packaging plant data exchange can at least indirectly communicate via the data input interface with a program module of other equipment/components and/or applications of the packaging plant (e.g. receive data from the other components and/or applications of the packaging plant and/or send error and/or confirmation notifications and/or commands to other components and/or applications of the packaging plant). If in the following we are talking about a program module, this can also be understood as an instance of a program module.

The communication takes place when a packaging device or components and/or application of the packaging plant communicates via the data input interface using a program module (e.g. a plug-in).

A program module can, for example, be adapted to the equipment/component and/or application of the packaging plant. For example, a program module is set up to prepare and/or convert data received from the equipment/component and/or application of the packaging plant (e.g. convert to a specified data format) and then output it via the data input interface or communicate it via the data input interface. Alternatively or additionally, such a program module is set up, for example, to process and/or convert confirmation and/or error notifications received via the data input interface (e.g., to convert them into a specified data format) and then, if necessary, forward them to the device/component and/or application of the packaging plant.

Two things can be achieved by adapting a program module to a particular component or packaging device. On the one hand, the program module can communicate via a standardized data input interface. This data input interface can be implemented identically for all types of program modules. In particular, each program module can implement an instance of a data input interface that can be accessed by the packaging plant data exchange.

On the other hand, a program module can be configured for one application purpose at a time. It has been recognized that different packaging equipment/components provide their data in very different ways via partly proprietary machine interfaces and require different data models and data structures. The packaging plant data communication does not have to worry about such manufacturer-specific or installation-specific influences anymore. A system integrator only has to create a suitable program module for the respective equipment interface and can then access the full range of functions of the packaging plant data exchange. The creation of more complex status data and the calculation of system parameters can also be individually provided in a program module.

Status data or status values are accessed via an access interface (preferably only via the access interface) and status data or status values are communicated to the packaging plant data exchange system via the data input interface (preferably only via the data input interface).

Via the data input interface, the packaging plant data exchange can receive packaging plant status data of equipment/components and/or applications of the packaging plant via the respective adapted program module.

It has now been recognized that information on the packaging equipment of the packaging plant must first be made known for data processing in the packaging plant data exchange. For this purpose, the program module may create at the data input interface a machine data object comprising at least metadata of the packaging device. The machine data object is suitable for describing a machine. Alternatively or cumulatively, the program module at the data input interface can also create a status data object comprising at least metadata of the status object and a status value of the packaging device. Create can be understood to mean that a data object is instantiated and/or that a status date is created in an object and/or that a status value is created or changed in an object.

Preferably, the data input interface provides means with which the program module can create the status data object in the packaging plant data exchange or at the data input interface. For this purpose, instances of a status data object/machine data object can first be created at the data input interface and the program module can set the metadata of the status object/machine data object and status data and/or status values of the packaging device in the instance of a status data object/machine data object.

The metadata of the machine data object preferably includes different data fields. The data fields can contain a unique identifier, a name, a serial number and/or a machine category. Furthermore, a name of a program module, information as to whether the machine is connected to or communicates with the program module and/or a software version of the program module can be stored.

Here, the data input interface provides means with which the program module can create a machine data object in the packaging plant data transfer or data input interface. For this purpose, instances of machine data objects can first be created at the data input interface and the program module can set the metadata in the instance of a machine data object.

Thus, the program module can be used to make a packaging device known in a standardized form of packaging plant data exchange.

A status data object can contain both status values and metadata, as well as functions. You can use the functions to execute rules on the status data object. A function can, for example, return values that correspond to a filter criterion. A function can, for example, check equality with a given instance of another status value object and return a corresponding Boolean value.

A condition value of a packaging plant can be understood, for example, as a characteristic value for a current and/or a past condition of the packaging plant and/or a component of the packaging plant. Examples of such a status value are, for example, a measured value recorded by a sensor of the packaging plant and/or a component of the packaging plant and/or a key figure of the packaging plant and/or a component of the packaging plant such as a line and/or component performance (e.g. packaging/hour) and/or an Overall Equipment Effectiveness (OEE). This can also be understood as plant parameters.

A status data object as well as a machine data object can contain an instance of a unique identifier. The unique identifier can also be a data object and can be loaded as an instance in an instance of a status data object and/or a machine data object. The data object of the unique identifier can contain functions and values. The functions allow, for example, to serialize the data object, to create a hash code for the data object, to check for equality with a transferred instance of another data object.

Using the status value, states (variables) of the packaging equipment of the packaging plant data exchange can be stored in a standardized form. Metadata of the status object allows to describe the status object. The metadata can be used to uniquely identify a status object. You can use the metadata to find a status object. With the help of the metadata, a status object can be suitably further processed. The metadata of the status object preferably includes different data fields. The data fields can contain a unique identifier or an instance of a unique identifier object, a name, a name of a program module, a unique identifier of the data source or an instance of a unique identifier object, a unique identifier of the component/institution or application from which the status object is introduced into the packaging plant data transfer or an instance of a unique identifier object, a unique identifier of the component/institution or application from which the status value originates, or an instance of a unique identifier object, a category, a data type, a synonym and/or an identifier.

The status values can preferably be stored as word (integer), string or double word. The unit and/or type of measurement can be stored in the Category and Data Type metadata.

Some packaging equipment has a standard machine interface. Data can be exchanged via the machine interfaces, especially according to the PackML standard. The machine interfaces can preferably be addressed via the transport protocol OPC UA. In the case of a standard interface, the program module can query metadata of the packaging device via the machine interface of the packaging device. The metadata of the packaging device can be understood as a “type plate”. The metadata can be read out in a standardized way and made available in a standardized form in a machine data object by the program module of the data input interface.

There are also packaging machines that have a proprietary machine interface. In particular, metadata on the packaging equipment cannot be retrieved via such an interface in some cases. In order to integrate such a packaging device into the packaging plant data exchange, it is now proposed that the metadata of the packaging device can be set, edited and, in particular, programmed in the program module, and that the program module provides this metadata of the packaging device for the machine data object. The system integrator must create an individually adapted program module for such packaging equipment, which can independently define the metadata of the machine data object. Thus, a packaging device with a proprietary interface can also be integrated.

As mentioned above, there are packaging machines that have a proprietary machine interface. Metadata for the status data cannot be retrieved via the machine interface, at least in part. In order to integrate the status data of such a packaging device into the packaging plant data exchange, it is now proposed that the program module should contain adjustable, editable and, in particular, permanently programmed metadata of the status object, which are then assigned to these status values via the machine interface of the packaging device when status values are read in and made available for the status data object. The system integrator must create an individually adapted program module for such packaging equipment, which can independently define the metadata of the machine data object. Thus a packaging device with a proprietary machine interface can also be integrated.

Status data of the packaging equipment are necessary for processing plant parameters. It is suggested that the program module queries the status value via the machine interface of the packaging device and provides the received status value for the status data object. The program module thus creates a status data object or an instance of a status data object in which metadata and/or status values can be stored. A status data object can, for example, be created at intervals, e.g. cyclically or when the status value is changed, and made available to the data input interface in the standardized format by the program module.

As mentioned above, some packaging equipment has a standard machine interface. These can be used to exchange data, especially in the PackML standard. These machine interfaces can preferably be addressed using the transport protocol OPC UA. In the case of a standard interface, the program module can query metadata of the status data object via the machine interface of the packaging device and provide the received metadata for the status data object. The metadata can be read out in a standardized way and made available in a standardized form in a machine data object by the program module of the data input interface.

To filter status data objects, they are preferably provided with an identifier with which status data objects can be assigned to specific groups. Such an identifier, also called tag, can be specified by the program module. The data model can specify a list of available identifiers from which one can be selected. This leads to a uniform grouping of status data objects.

As already explained, the objective of this packaging plant data exchange is to facilitate the system integration of various packaging plants. This is also achieved by the fact that the data input interface for creating instances of machine objects and status data objects is set up in a uniform data model. The uniform data model simplifies the processing of the data in the packaging plant data transfer through different components, facilities and applications, as these can act independently of each other. None of the components, devices, applications needs knowledge about other components, devices, applications have. The program modules and database modules can access a unified set of data (instances of data objects), although two or more different packaging devices may be integrated into the system. Each packaging device and each state is uniformly represented in the system by at least one instance of a machine data object and/or a status data object. The integration of new packaging equipment into the system is simplified since only one program module has to be adapted to the packaging equipment at a time, but the data input interface to the packaging equipment data transmission remains identical. Even new packaging facilities are not perceived as such by the existing program modules, since access from their machine data objects and status data objects runs according to the uniform data model.

The status data are made available exclusively via a program module which follows the data model of the packaging plant data exchange and is adapted on the other hand for the respective area of application, in particular adapted to a machine interface of a packaging device.

Examples of a condition value are a measured value recorded by a sensor of the packaging plant and/or a component of the packaging plant and/or a key figure of the packaging plant and/or a component of the packaging plant such as a line and/or component performance (e.g. packaging/hour) and/or an Overall Equipment Effectiveness (OEE). This can also be understood as plant parameters.

The at least one first condition value represented by the first packaging plant condition data is stored, for example, in a database (a persistent memory) that does not need to be part of the packaging plant data communication. For example, the persistent memory is part of a database system different from the packaging plant data exchange. The persistent memory serves, for example, for the permanent storage of the status values obtained by the packaging plant data exchange. For example, historical and current status values for various states of the packaging plant are stored in the persistent memory. A current condition value is to be understood as a value representative of a current condition of the packaging plant. This is, for example, the status value for this state, which is represented by packaging plant state data that was last received for this state by an instance of the packaging plant data transfer. A status value can also be calculated and provided by a program module in particular. Accordingly, a historical condition value for a condition is, for example, a condition value represented by packaging plant condition data that was previously received (i.e., before the last packaging plant condition data received for that condition) by the packaging plant data brokerage. Status values can be stored in a status date (variable). Current and historical status values can be stored. It can be useful if status values are stored in a temporal sequence, especially serially one after the other.

The packaging plant data exchange preferably provides a data storage interface for communicating with the persistent memory. It is understood that the packaging plant data communication through the data storage interface communicates with the persistent storage via a database module (e.g. send data objects to be stored to the persistent storage and/or receive storage error and/or storage confirmation notifications from the persistent storage).

By adapting the database module to a persistent memory, it is achieved that the packaging plant data transfer can work with different data memories, whereby one database can be addressed by a database module adapted for this purpose. The database module can communicate with a standardized data storage interface. This data storage interface can be identical for all types of database modules. The data storage interface can also work with the same data model as the data input interface. On the other hand, a database module can be configured for at least one database at a time. It was recognized that different databases make their data available or read in in very different ways via partly proprietary interfaces and require different data models and data structures. The packaging plant data communication does not have to worry about such manufacturer-specific or installation-specific influences anymore. A system integrator only has to create a suitable database module for the respective database and can then access the full range of functions of the packaging plant data transfer.

With the help of the packaging plant data transfer in question, data consistency is ensured for all connected equipment/components and applications. It is ensured that all status data objects and machine data objects are reliably accessible for all equipment/components and applications and that a high level of data security is guaranteed. Furthermore, it is ensured that a uniform data structure, a uniform data model and central data storage for the entire packaging plant ensure that all facilities/components and applications working with it always have the same data basis. Storage and access conflicts are prevented. It also prevents status data from being stored inconsistently.

Status data objects within the packaging plant data transfer can be uniquely identified. For this purpose, the status data objects can be identified using metadata, for example. Such metadata can, in particular, be the criteria that uniquely identify the state data (unambiguous connoisseur). Such a unique identifier can be a name and a data source within the metadata. The packaging plant data transfer thus ensures consistency of the data.

To ensure that the cache, the data input interface and the data storage interface can access the status data reliably and unambiguously, they form a common switching network. Furthermore, in order to ensure that data within the packaging plant data exchange can only be changed via the above interfaces, it is proposed that a program module can only exchange status data with the packaging plant data exchange via the switching network. The program modules are preferably transparent to each other and cannot communicate with each other. Rather, all communication takes place exclusively via the packaging plant data exchange and in particular exclusively via the data input interface and the access interface. Consequently, it is also proposed that the cache, the data input interface and the data storage interface be operated independently of each other. This means that instances of program modules communicate independently of each other via a data input interface and an access interface. Communication between the interfaces preferably takes place exclusively via a message bus. This is integrated in the switching network. Access to one of the interfaces is not immediately noticed by the other interfaces. Each instance of a program module automatically carries out the data communication with the assigned interfaces.

It is also proposed that the data input interface be set up for communication with a program module that determines at least one packaging plant parameter. Packaging plant parameters can be understood as status data objects. As already explained, packaging plant parameters such as OEE or other information concerning the packaging plant can be calculated from the packaging plant condition data. Each of these calculations requires at least read access to the packaging plant condition data. The results of the calculation can be fed into the data transmission system as new packaging plant status data via the data input interface. This means that a program module, which is set up to calculate packaging plant parameters, first reads the status data and then, if a packaging plant status value is changed or calculated, feeds this status value via the data input interface into the packaging plant data exchange.

As already explained, packaging plant condition data can be formed from metadata and condition values. With the help of the metadata, the status data in particular can be uniquely identified and assigned. The status values then describe certain states, in particular values recorded by sensors or values calculated using algorithms.

It is often necessary for program modules to access packaging plant status data. In order to initiate such an access, the program modules must have knowledge of the packaging plant status data available within the packaging plant data exchange. To make this possible, the cache preferably has a read interface that allows immediate read access to at least the metadata.

The buffer memory is equipped in such a way that it preferably temporarily stores status data, in particular in the form of a cache. It is not necessary for the buffer memory to hold all status data permanently. In particular, it is possible that the cache only holds metadata in parts. It is also possible that the cache only holds a subset of all available status data or their metadata. It is proposed that, to start the system, the cache preferably retrieves metadata on all available state data from the persistent data store and makes it available for subsequent retrieval by the program modules or within the data brokering. The status values can then be reloaded from the database as required if program modules want to access them.

However, it is also possible that certain state data is not available as metadata or as status values in the buffer. In order to provide the program modules with all available status data, it is suggested that the cache first searches internally for packaging plant status data when an availability of packaging plant status data is queried. If no information is available internally for a query, i.e. a negative search result is available, the cache can be equipped in such a way that it searches for corresponding packaging plant status data in the database via the data memory interface. If corresponding status data is found in the database, the metadata for this can preferably first be made available to the buffer via the data memory interface.

According to an embodiment, it is proposed that access to the data storage interface is only triggered by the packaging plant data exchange, whereby access to the data input interface is triggered via a program module. The data storage interface can preferably only be accessed via the buffer so that consistent data storage in the database is ensured. Read accesses and/or write accesses to status data via the program modules are preferably carried out via the data input interface and/or the access interface.

The program modules cannot communicate with each other. The program modules are transparent to each other. Direct communication between two program modules is prevented. This ensures that any changes to status data are transmitted via the data link.

For example, the persistent memory is arranged to communicate a corresponding memory confirmation notification to the data memory interface when the at least a first status value represented by the packaging plant state data has been stored in the persistent memory. Further, the persistent memory is arranged to communicate a corresponding memory error notification to the data memory interface when the at least a first status value represented by the packaging plant state data has not been stored in the persistent memory.

According to an embodiment, the persistent memory is set up for the permanent storage of current and historical status values of the packaging plant. As shown above, the persistent memory will store, for example, historical and current status values for different states of the packaging plant.

According to an embodiment, the packaging plant data exchange is provided by one or more server devices and/or by one or more virtual servers. A packaging plant data exchange is, for example, the part of the packaging plant data exchange provided by a server device or a virtual server.

According to an embodiment, a condition value of the packaging plant represents a measured value recorded by a sensor of the packaging plant.

For example, the status value may contain the measured value and/or correspond to the measured value. Alternatively or additionally, the status value can also contain a counter value and/or a logical value, for example. Such a counter value may, for example, represent the frequency that the measured value was detected by the sensor; such a truth value may indicate, for example, whether the measured value is greater than a threshold value and/or less than a threshold value and/or equal to a threshold value.

Examples of sensors for measuring the measured value are a temperature sensor, a light barrier sensor, a pressure sensor, a humidity sensor, a camera, a voltage sensor and/or a level sensor.

A computer program may include program instructions that cause a processor to execute and/or control the procedure in question when the computer program is executed by the processor. Either all steps of the process can be controlled, or all steps of the process can be executed, or one or more steps can be controlled and one or more steps can be executed.

In this specification, a processor shall be understood to include control units, microprocessors, microcontroller units, digital signal processors (DSP), application-specific integrated circuits (ASICs) or field programmable gate arrays (FPGAs).

For example, the computer program can be distributed over a network such as the Internet, a telephone or mobile network, and/or a local network. The computer program can be at least partially software and/or firmware of a processor. It can also be at least partially implemented as hardware.

For example, the computer program may be stored on a computer-readable storage medium, such as a magnetic, electrical, optical and/or other storage medium. For example, the storage medium may be part of the processor, such as a (non-volatile/persistent or volatile) program memory of the processor or part of it. The storage medium can, for example, be an objective or physical storage medium.

A server device may be arranged to execute and/or control the process in question or may include respective means for executing and/or controlling the steps of the process. Either all steps of the procedure in question can be controlled by the means, or all steps of the procedure according to the invention can be executed by the means, or one or more steps can be controlled by the means and one or more steps can be executed by the means. Different steps can optionally be performed or controlled by different means. A server system comprising a plurality of server devices and/or a plurality of virtual servers may be arranged to execute and/or control the process in question or may include respective means for executing and/or controlling the steps of the process in question. For example, the server devices and/or the virtual servers are set up to jointly execute and/or control the process in question. It is understood that either all the steps of the present procedure are controlled by the means of the server devices and/or the virtual servers, or all the steps of the inventive procedure are performed by the means of the server devices and/or the virtual servers, or one or more steps are controlled by the means of the server devices and/or the virtual servers and one or more steps are performed by the means of the server devices and/or the virtual servers. Different steps can optionally be performed or controlled by different means of different server devices and/or virtual servers. The server devices and/or the virtual servers of the server system may be located in one or more locations. For example, the server devices and/or the virtual servers of the server system form a server cloud and/or a distributed system. Multiple virtual servers can run simultaneously on one server device. A virtual server is the software and/or hardware replica of the hardware architecture of a (physical) server device by the providing server device.

The means of the disclosed server device(s) may include hardware and/or software components. The means may include, for example, at least one memory containing program instructions of a computer program (e.g., the computer program in conformity with the invention) and at least one processor designed to execute program instructions from the at least one memory. Accordingly, at least one server device comprising at least one processor and at least one memory with program instructions should also be understood as revealed, wherein the at least one memory and the program instructions are arranged, together with the at least one processor, to cause the server device to execute and/or control the method according to the invention at least partially (e.g. alone or together with several server devices of the server system).

A system comprising a server device or server system; and a packaging plant according to the subject matter is also disclosed.

The embodiments described above should also be understood as being disclosed in all and any combinations with each other.

If this description refers to a data object, it is understood that it can also refer to an instance of such a data object.

Further advantageous embodiments can be found in the following detailed description of some embodiments, especially in connection with the figures. However, the figures enclosed with the application are only intended to clarify the scope of protection of the invention and not to determine it. The enclosed drawings are not necessarily true to scale and are merely intended as an example of the general concept of the invention at hand. In particular, features contained in the figures should by no means be regarded as a necessary component.

In the following, the subject matter is explained in more detail using a drawing showing embodiments. In the drawing show:

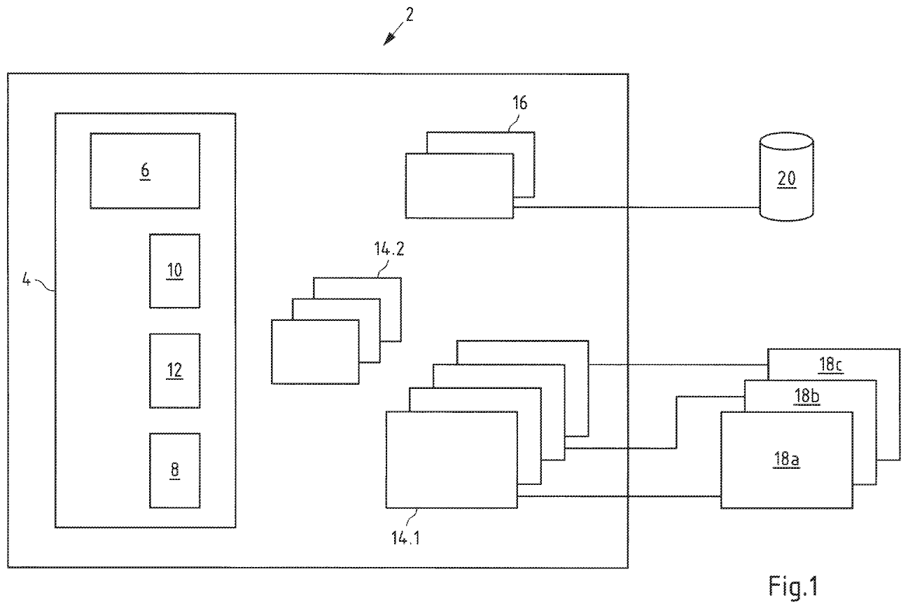

FIG. 1 a packaging plant data exchange according to an embodiment;

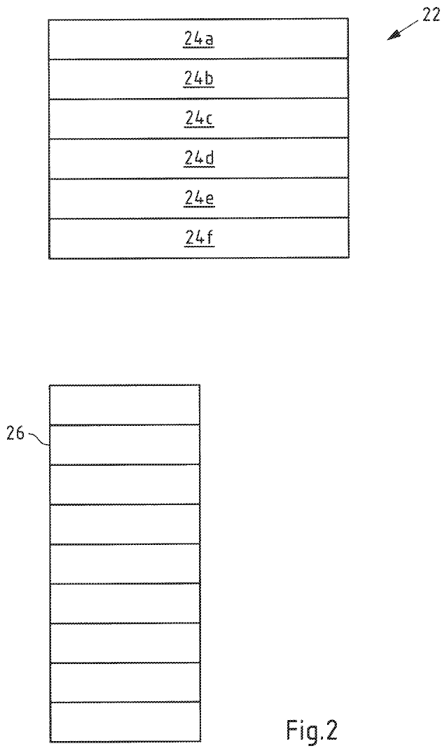

FIG. 2 a data model of a machine data object;

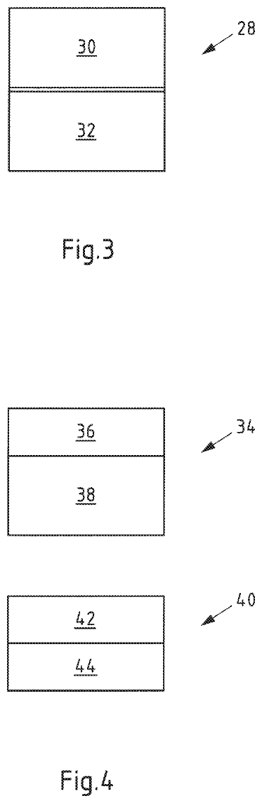

FIG. 3 a data model of a data object “unique identifier”;

FIG. 4 a data model of a status data object.

The embodiment of the present invention described in this specification should also be understood as being disclosed in all combinations with each other. In particular, the description of a feature covered by an embodiment—unless explicitly stated otherwise —should not be understood in the present case to mean that the feature is indispensable or essential for the function of the embodiment. The sequence of the process steps described in this specification in the individual flow diagrams is not mandatory, alternative sequences of the process steps are conceivable. The process steps can be implemented in different ways, e.g. an implementation in software (by program instructions), hardware or a combination of both to implement the process steps is conceivable. Terms used in patent claims such as “include”, “exhibit”, “include”, “contain” and the like do not exclude other elements or steps. The expression “at least in part” covers both the case “in part” and the case “in full”. The wording “and/or” should be understood as meaning that both the alternative and the combination should be disclosed, i.e. “A and/or B” means “(A) or (B) or (A and B)”. A plurality of units, persons or the like means, in the context of this specification, several units, persons or the like. The use of the indefinite article does not exclude a plurality. A single entity may perform the functions of several entities mentioned in the patent claims. The reference signs indicated in the patent claims are not to be regarded as limitations of the means and steps used.

FIG. 1 shows a packaging plant data exchange 2. Packaging plant data exchange 2 can be executed in a runtime environment, a server, a virtual server or the like. Here, in a switching network 4, which can be part of the packaging plant data exchange 2, a buffer memory 6, a data input interface 8, a database interface 10 and an access interface 12 can be implemented.

In addition, packaging plant data exchange 2 has an environment in which program modules 14.1, 14.2 as well as database modules 16 (or respective instances thereof) can be executed.

It can be seen that the program modules 14.1 can be configured as system program modules 14.1 and can each communicate with a packaging device 18a-c. In addition, a database module 16 can communicate with a database 20.

Program modules 14.1 can be individually adapted to a wide range of packaging equipment 18a-c. For example, a packaging device 18a may be a filling device provided by a first manufacturer, whereas a packaging device 18b may be a filling device provided by a second manufacturer. A packaging device 18c, for example, can be a tray packer or another device that can be operated within a packaging plant and that can output status data. The packaging devices 18a-c each have individual machine interfaces to be able to output their status data. The status data can be retrieved from the packaging equipment 18a-c in various data formats via various machine interfaces and in different ways so that uniform access to them is impossible. Changes may also occur at the machine interfaces of the packaging device 18a-c in the course of further developments, which must be mapped.

Program modules 14.1 are provided for this purpose. Each program module 14.1 can be individually adapted for a single 18a-c packaging device. Thus, a program module 14.1 can be used to individually access a machine interface of a respective packaging device 18a-c and read out its respective status data.

Using a defined data model, the program modules 14.1 can create the condition data received from the packaging facilities 18a-c as packaging facility condition data or instances of condition data objects and machine data objects in packaging facility data transfer 2. Both metadata and status values can be made available in a uniform data format. The data format can define variables, machines or lines. Depending on the data format, the status data can contain metadata and status values. For example, metadata can contain a name, an origin, a target, an origin, synonyms, or tags. This allows the various status data to be described in a uniform data format.

Using variables, data points, in particular status values of various sensors, can be mapped. Machines can be used to map properties of machines and lines can be used to define links between machines and the layout of the packaging plant.

The buffer 6 can store current instances of status data objects and machine data objects. For persistent storage, it may be useful to store the status data in a database.

Similar to the packaging equipment 18a-c, there are 20 different databases with different database protocols and database interfaces. In order to provide the highest possible flexibility for the packaging plant data transfer 2 or a system integrator, database modules 16 can be provided, which are individualized for each database 20. It goes without saying that both the program modules 14.1 and the database modules 16 must only be made available for the packaging equipment 18a-c and databases 20 available in the packaging plant Individualisation can be based on the equipment, components and applications available in the packaging plant, so that program modules 14.1 and database modules 16 only have to support what is available.

In addition to the database modules 16 and the program modules 14.1, further program modules 14.2 can be provided with which, for example, information about the packaging plant can be calculated from status values. Such applications can also be provided as program modules 14.2 in packaging plant data exchange 2.

Various additional functions can be made available within the switching network 4. For example, a safety function can be provided. This can be used to monitor write/read rights for various status data. It can be monitored which of the interfaces 8-12 can access status data. It is also possible to monitor which of the program modules 14.1, 14.2 can access data. Furthermore, a user management system is available with which access rights can be assigned to users and users can log in or log out. In addition, a logbook function can be provided for logging actions within the switching network 4. In addition, standard functionalities can be provided, such as handling exceptions, loading program modules, debugging or the like.

For example, a packaging device 18a may be a machine having a machine interface through which data can be exchanged in a standardised format. This format can work according to the PackML standard, for example. The machine interface can also support the transport protocol OPC UA. A first program module 14.1, which communicates with the packaging device 18a via the known machine interface, can be provided to connect such a packaging device, which has a standardized machine interface. In order to integrate the packaging device 18a into the packaging plant data exchange 2, the program module 14.1 can first retrieve information about the machine itself from the packaging device 18a.

Using this information, program module 14.1 then creates an instance of a machine data object using the data input interface 8 and fills this instance with the information retrieved from packaging equipment 18a. For this purpose, a corresponding method can be provided at the data input interface 8 which can be used to create the instance of the machine data object.

A second packaging unit 18b can also be connected to the packaging plant data exchange 2. For this a second program module 14.1 can be provided, which is adapted to the packaging device 18b. Since the packaging device 18b, for example, unlike the packaging device 18a, does not have a standardized machine interface, the second program module 14.1 cannot access machine parameters in a standardized form either. In particular, the packaging device 18b may be such that no machine information can be retrieved via its machine interface. In this case, the second program module 14.1 may contain coded, entered, parameterized and/or edited knowledge about the machine. At the data input interface 8, the second program module 14.1 can now also instantiate an instance of a machine data object and enter the coded information about the machine in this instance.

It turns out that for each type of machine or packaging device, an instance of a machine data object can be created by a program module 14.1 via the data input interface 8.

FIG. 2 shows a machine data object 22. The machine data object 22 can have different property fields that are defined in the data model. The data types of the property fields 24a-f are fixed in the definition of the data model. When instantiating an instance of a machine data object 22, these property fields 24a-f can be filled with values from program module 14.1.

A first property field 24a, for example, can be a name field which has the data type “String”. For example, a second data field 24b can be a string and contain a serial number. For example, a third data field 24c can be an object data field that contains an object of type “enumeration”. In such an object, for example, machines can be stored in categories.

A data model of such an enumerated object is also shown. In this enumeration object 26, various machine types can be predefined and an instance of such a data object can contain one of the predefined values. For example, values can describe packaging equipment such as filling equipment, applicators, storage tables, conveyor belts, robots, tray packers, printers, switches, scanners or the like. The corresponding machine properties can be predefined in the data model.

A further property field 24d can, for example, contain the name of the program module (plug-ins) and be specified as a string. An additional property field 24e can, for example, indicate whether the machine is connected to the program module or communicates with the program module or not and can be coded as a boolean value, for example. For example, another property field 24f may contain a unique identifier and may be defined as a “unique identifier” object.

FIG. 3 shows a data model of an object “unique identifier” 28. Such a data object 28 can contain both functions 30 and properties 32. Possible functions of such a data object can be, for example, a function that is passed another data object 28 and that returns whether the passed data object matches the data object 28. The return value can be a boolean value. A function can also contain the return of a hash code of the data object 28, whose value can be defined as an integer. Finally, a function can also contain a conversion of the data object 28 into a string, for example for serialization.

In addition to the functions 30, the properties Name and Type can be defined in a data object 28, whereby the name can be defined as a string and the type can be an object of type Enumeration.

A data object of the enumeration type for the Type property can be, for example, a machine, setup, program module, or external system. This can be used to determine how the corresponding data object was introduced into the system.

At the runtime of the packaging plant data transfer 2, an instance of the data object 22 is created and during this creation, in addition to the properties 24a-d, an instance of an enumerated object 26 with a corresponding value and an instance of an object “unique identifier” 28 with the corresponding values is instantiated. This instance of data object 22 then represents a machine or packaging device 18a, b.

During operation of packaging equipment 18a, b, for example for packaging 18.a, program module 14.1 can first instantiate one or more data objects of the type status data. Program module 14.1 instantiates a corresponding instance at the data input interface 8 for this purpose.

Via the machine interface of the packaging device 18a, both metadata of the status object and status data are available to the program module 14.1. First, the metadata of the status object is read from machine 18a and entered in the instance of the status data object. In addition, program module 14.1 can create an identifier (tag) which can also be read out via the machine interface of the packaging device 18a.

A proprietary machine interface is available for the packaging device 18b. In this case, program module 14.1 can be programmed to retrieve the states via the proprietary interface. Knowing the retrievable information, the program module 14.1 can transfer this metainformation or metadata of the respective instance via the data input interface 8 when instantiating corresponding status data objects.

For both the packaging device 18a and the packaging device 18b, a set of status data objects can then be instantiated via a respective program module 14.1, while metadata is either provided via the machine interface or stored in a program module 14.1.

FIG. 4 shows a data model of a status data object. A status data object can contain a metadata object 34 with both functions 36 and properties 38.

A method 36, for example, could be checking for equality. A status data object or an instance thereof can be passed to this method and a Boolean return value can specify whether the passing data object matches the actual data object.

Properties 38 can contain the name of the status data object as string and the name of the program module 14.1, which instantiated the object, as string.

In addition, as properties 38, as instances of data objects 28, the source of the data object can be, namely who has introduced this data object into the system and the target of the data object, namely to whom the data object belongs within the system.

Another property can be a value object, which can contain an instance of an enumerated object. For example, a value category can contain a raw signal, a raw time series, a calculated time series or a calculated signal.

Another property can be a data type that comes from an enumerated data type object and can be encoded as a word, double word, or string, for example.

Finally, synonyms and identifiers can be provided, each of which can be instances of corresponding data objects. For example, synonyms may contain descriptions for the measurement unit. The identifiers can, for example, be freely definable strings.

In addition to the data object 34 for the metadata, another data object 40 can be provided for the status value. This data object 40 can also contain functions 42 and values 44.

Functions 42 may contain an equality check and a return function of a value. The return function can pass filter information about certain values and return lists of values corresponding to the filter function.

A value can be an object of an instance of a value object in which, for example, a time stamp and/or an actual measured value can be stored. Such a data object can also contain a function that can check for equality.

Using the data model described, it is possible for various program modules 14.1 to create 8 instances of machine objects and status objects at the data input interface.

If a program module 14.1 detects a change in value at the machine interface of the packaging device 18a, you can change the value at the data input interface 8 using the corresponding instance of the status object using a corresponding method. The same can be done by a second program module 14.1 which is connected to a proprietary packaging device 18b. Here, too, value changes can be transferred via corresponding methods to the data input interface 8 using the instances of the respective status data objects.

Program modules 14.2 can, for example, calculate a key figure OEE (Overall Equipment Effectiveness). A program module 14.2 can do this regardless of the machine type of the packaging device 18a, 18b, since the machine data as well as the status data can be made available as standardized data objects via the access interface 12 and the buffer 6.

First, the program modules can instantiate a status data object with a tag (status) at the data input interface 8. The Target property of the respective status data object is created using the unique identifier of the respective machine. Thus the program modules can address the status data objects with the type status for each of the machines.

If value changes now take place at the corresponding machines or status data, this is communicated to the program module 14.2 via the access interface 12. The program module can then read the value from the buffer via a read interface. In the program module 14.2 a new value of the state can be calculated. Via the data input interface 8, the value of the status within the status data object can be overwritten or supplemented with a new corresponding method.

1. A system comprising,
a packaging plant data exchange with
at least one buffer for packaging plant condition data comprising condition values,
at least one data input interface, and
at least one program module adapted to a packaging device of the packaging plant wherein
the program module is arranged for communicating with the packaging pant data exchange via the data input interface,
characterized in that
the data input interface provides means with which the program module instantiates at the data input interface
a) a machine data object, comprising at least metadata of the packaging device, and/or
b) a status data object comprising at least metadata of a status object and a status value of a status date of the packaging device.

2. The system according to claim 1,
characterized in that
the program module receives the metadata of the packaging device via a machine interface of the packaging device and makes the received metadata of the packaging device available for the machine data object.

3. The system according to claim 1,
characterized in that
the metadata of the packaging device are preset, in particular programmed, in the program module, and the program module provides the programmed metadata of the packaging device for the machine data object.

4. The system according to claim 2,
characterized in that
the program module assigns preset, in particular programmed metadata of the status object to the status values received via the machine interface of the packaging device and makes them available for the status data object.

5. The system according to claim 2,
characterized in that
the program module receives the status value via the machine interface of the packaging device and provides the received status value for the status data object.

6. The system according to claim 2,
characterized in that
the program module receives metadata of the status data object via the machine interface of the packaging device and provides the metadata received for the status data object.

7. The system according to claim 1,
characterized in that
the metadata of the status data object comprises the data type, the data unit, the data source, the scaling of the data and/or the data category.

8. The system according to claim 1,
characterized in that
the program module assigns an identifier to the status data object as a function of the received and/or preset metadata of the status data object, with which identifier the status data object is to be assigned to a group of status data objects.

9. The system according to claim 1,
characterized in that
the data input interface is set up to obtain, receive, create and/or instantiate machine objects and status data objects in a uniform data model.

10. The system according to claim 1,
characterized in that
the data input interface is set up for communication with a program module which determines at least one packaging plant parameter.

11. The system according to claim 1,
characterized in that
direct communication is prevented between at least two program modules.

12. The system according to claim 1,
characterized in that
the packaging plant data exchange is provided by one or more server devices and/or by one or more virtual servers.

13. The system according to claim 1,
characterized in that
the at least one status value of the packaging installation represents a measured value detected by a sensor of the packaging device.

14. A method comprising:
receiving packaging plant status data by a data input interface of a packaging plant data exchange, wherein the packaging plant status data represent at least one status value of a packaging plant; wherein
at least one program module adapted to a packaging device of the packaging pant communicates with the packaging plant data exchange via the data input interface,
characterized in that
the data input interface provides means with which instances of
a) a machine data object, comprising at least metadata of the packaging device, and/or
b) a status data object comprising at least metadata of a status object and a status value of a status date of the packaging device
are instantiated by the program module.

15. The method according to claim 14 comprising:
detecting at least one first measured value by a sensor of the packaging device; and
communicating and/or effect the communication of packaging plant condition data to the data input interface via the program module.

16. A computer program comprising program instructions which cause a processor to execute and/or control the method according to claim 14 when the computer program is executed by the processor.

17. A server device or a server system comprising a plurality of server devices and/or virtual servers arranged to execute and/or control the method according to claim 14.
